(19) United States
(12) Patent Application Publication
(10) Pub. No.: US 2025/0109819 A1
(43) Pub. Date: Apr. 3, 2025

(54) LOCKING ASSEMBLY, DRIVING-TYPE LOCKING MECHANISM, TELESCOPIC SUPPORTING LEG, AND TRIPOD

(71) Applicant: Dongguan Filmspider Technology Co., Ltd., Dongguan (CN)

(72) Inventors: Zhihao LIANG, Dongguan (CN); Wangeng FENG, Dongguan (CN)

(73) Assignee: Dongguan Filmspider Technology Co., Ltd., Dongguan (CN)

(21) Appl. No.: 18/981,368

(22) Filed: Dec. 13, 2024

Related U.S. Application Data
(63) Continuation-in-part of application No. PCT/CN2023/080964, filed on Mar. 13, 2023.

(30) Foreign Application Priority Data
Sep. 20, 2022 (CN) 202211144959.3

(51) Int. Cl. F16M 11/32; G03B 17/56; G05B 24/02

(52) U.S. Cl. CPC F16M 11/32; G03B 17/561; G05B 24/02

(57) ABSTRACT

The present invention relates to the technical field of photographic apparatuses, and in particular, to a locking assembly, a driving-type locking mechanism, a telescopic supporting leg, and a tripod. The locking assembly includes a fixing base and a rotating shaft member, an abutting component is fixedly sleeved on a periphery of the rotating shaft member, and an elastic component and a movable component are disposed on the periphery of the rotating shaft member. The driving-type locking mechanism includes a driving component and the locking assembly. The telescopic supporting leg includes the driving-type locking mechanism, an upper sleeve, and a lower sleeve. The tripod includes a tripod base, an operating component, and three telescopic supporting legs. According to the present invention, a transmission member is not needed to provide locking force or locking torque for the locking assembly.

### CROSS-REFERENCE TO RELATED APPLICATIONS

The application claims priority to Chinese patent application No. 202211144959.3, filed on Sep. 20, 2022, the entire contents of which are incorporated herein by reference.

### TECHNICAL FIELD

The present invention relates to the technical field of photographic apparatuses, and in particular, to a locking assembly, a driving-type locking mechanism, a telescopic supporting leg, and a tripod.

### BACKGROUND

To adapt to adjusting the length of a foot tube of a supporting device in the field of photographic equipment, for example, to adjust the length of a foot tube of a tripod, the foot tube is composed of a plurality of groups of sleeved inner tubes and outer tubes. After adjusting to the target length, the commonly used locking structures currently include two types: one is spiral locking, which is as shown in Publication No. CN99245379.8, and the other is pull buckle locking, which is as shown in Publication No. CN201420843756.8. For the spiral locking, the advantage is that the locking force is strong, and the disadvantage is that the unlocking and locking require constant loosening and tightening, which is cumbersome to operate. For the pull buckle locking, the locking force cannot be adjusted, and the locking force decreases rapidly due to severe wear after long-term use.

In addition, currently, foot tubes of the tripod are all telescopically locked or unlocked by a single foot tube. When performing telescopic adjustment on the foot tubes of the tripod, a user can only perform unlocking or locking by operating one foot tube at a time, which is inconvenient to operate, has poor flexibility, and takes a long time to adjust. As shown in Publication No. CN202210139221.1, in lever locking, a transmission rod 16 needs to pry lever components 6 on both sides to move at the same time, the transmission rod 16 provides rotatory torque for a locking component, and a user needs to overcome huge operating torque when operating the transmission rod 16. Therefore, for each telescopic supporting leg of the tripod, only one supporting leg can be operated separately to perform a telescopic action, and three supporting legs cannot be controlled simultaneously to perform locking or unlocking to implement the telescopic action.

### SUMMARY

In view of the problems in the prior art, the present invention provides a locking assembly, a driving-type locking mechanism, a telescopic supporting leg, and a tripod. When the locking assembly is in a locking state, elastic force of an elastic component makes the locking assembly self-locking, and a transmission member is not needed to provide locking force or locking torque for the locking assembly, so that a user may drive, only by lightly applying force to a driving component, the transmission member to move to drive the locking assembly to perform unlocking to control position locking or releasing of the telescopic supporting leg. Since the transmission member may move by only applying small force, one operating component may simultaneously drive a plurality of transmission members to move. An operation is simple, use is convenient, and a problem that a traditional tripod needs to be adjusted through a plurality of unlocking and needs to be adjusted through an operation of two hands or cooperation of a plurality of persons is overcome, thereby greatly improving use convenience of the user.

To resolve the above technical problems, the following technical solutions are used in the present invention:

The present invention provides a locking assembly, including a fixing base and a rotating shaft member rotatably disposed on the fixing base, where an abutting component is fixedly sleeved on a periphery of the rotating shaft member, an elastic component and a movable component are disposed on the periphery of the rotating shaft member, the movable component is disposed on the periphery of the rotating shaft member in a manner of moving up and down, the movable component is provided with a locking groove, and a locking member is movably disposed in the locking groove; the rotating shaft member rotates to drive the movable component to move up and down to be close to or away from the abutting component; and in a locking state, the elastic component is compressed to enable the movable component to abut against the abutting component, and the abutting component abuts against the locking member to enable the locking member to extend out of the locking groove.

The abutting component includes a first abutting ferrule and a second abutting ferrule, and the first abutting ferrule and the second abutting ferrule are fixedly sleeved at an upper end and a lower end of the rotating shaft member respectively;
the movable component includes a first movable ferrule and a second movable ferrule, and the first movable ferrule and the second movable ferrule are located between the first abutting ferrule and the second abutting ferrule; and
the elastic component is located between the first movable ferrule and the second movable ferrule, and two ends of the elastic component abut against the first movable ferrule and the second movable ferrule respectively.

One side, abutting against the locking member, of each of the first abutting ferrule and the second abutting ferrule is provided with an abutting inclined surface configured to abut against the locking member in a matching manner.

Cross sections of the first abutting ferrule and/or the second abutting ferrule are of an isosceles trapezoid shape and/or a circular truncated cone shape.

The movable component further includes a first threaded ferrule and a second threaded ferrule, the first threaded ferrule and the second threaded ferrule are located between the first abutting ferrule and the second abutting ferrule, and the first movable ferrule and the second movable ferrule are located between the first threaded ferrule and the second threaded ferrule;
a left-hand thread or a right-hand thread of the upper end of the rotating shaft member is directly or indirectly connected to the first threaded ferrule, and a right-hand thread or a left-hand thread of the lower end of the rotating shaft member is directly or indirectly connected to the second threaded ferrule; and
the first movable ferrule is sleeved on a periphery of the first threaded ferrule in a manner of moving up and down, and the second movable ferrule is sleeved on a periphery of the second threaded ferrule in a manner of moving up and down.

A limiting annular platform is disposed on the periphery of the first threaded ferrule and the periphery of the second threaded ferrule respectively, an inner wall of the first movable ferrule is attached to the limiting annular platform of the first threaded ferrule in an abutting manner, and an inner wall of the second movable ferrule is attached to the limiting annular platform of the second threaded ferrule in an abutting manner.

A limiting assembly is disposed between the first threaded ferrule and the first movable ferrule and between the second threaded ferrule and the second movable ferrule respectively.

The limiting assembly includes at least one limiting rib and at least one limiting groove, the limiting rib is adapted and slidably connected to the limiting groove, the periphery of the first threaded ferrule and the periphery of the second threaded ferrule are provided with the limiting rib and/or the limiting groove respectively, and an inner wall of the first movable ferrule and an inner wall of the second movable ferrule are provided with the limiting groove and/or the limiting rib respectively.

The locking groove is a horizontal locking groove; and the locking member is an arc-shaped circular strip colloid or a plurality of beads movably arranged in the horizontal locking groove in a raw.

A peripheral wall of the first movable ferrule and a peripheral wall of the second movable ferrule are vertically provided with a vertical groove and/or a vertical rib respectively.

The present invention further provides a driving-type locking mechanism, including a driving component and the locking assembly, where the driving component is configured to drive the rotating shaft member to rotate.

The driving component includes a tube base, a driving head, a transmission member, and a reset spring, one end of the transmission member is connected to the driving head, the other end of the transmission member is connected to the rotating shaft member, the driving head is disposed in the tube base in a manner of moving up and down, the reset spring is configured to drive the driving head to reset, the transmission member is rotatable relative to the tube base, and the driving head is configured to drive the transmission member to rotate.

A connecting head is disposed at one end of the transmission member, a pin shaft is disposed on each of two sides of the connecting head, the connecting head is located in the driving head, each of two sides of the driving head is provided with an inclined groove, and the pin shaft on each of the two sides of the connecting head extends into the inclined groove.

A reset annular platform is fixedly disposed on a peripheral wall of the driving head, the reset spring is sleeved on a periphery of the driving head, and two ends of the reset spring abut against inner walls of the reset annular platform and the tube base respectively.

At least two limiting vertical shafts are disposed in the tube base, and the limiting vertical shaft slidably penetrates through the reset annular platform.

The driving component includes a tube base, a micro motor, and a transmission member, an output shaft of the micro motor is drivingly connected to one end of the transmission member, one end of the transmission member is connected to the rotating shaft member, the transmission member is rotatable relative to the tube base, and the micro motor is mounted in the tube base.

The present invention further provides a telescopic supporting leg, including the driving-type locking mechanism, at least one upper sleeve that is hollow, and a lower sleeve that can move up and down in the upper sleeve, where the driving component is mounted at an upper end of the upper sleeve, and the locking assembly is mounted at an upper end of the lower sleeve.

A peripheral wall of the movable component is vertically provided with a vertical groove and/or a vertical rib; and an inner wall of the upper sleeve and an inner wall of the lower sleeve are respectively provided with a matched vertical rib and/or vertical groove.

The present invention further provides a tripod, including a tripod base, an operating component mounted on the tripod base, and three telescopic supporting legs annularly disposed on a periphery of the tripod base in a uniformly-spaced manner;
the telescopic supporting leg includes a driving-type locking mechanism, at least one upper sleeve that is hollow, and a lower sleeve that can move up and down in the upper sleeve; and the driving-type locking mechanism includes a driving component and a locking assembly, the driving component is mounted at an upper end of the upper sleeve, the locking assembly is mounted at an upper end of the lower sleeve, and the driving component is configured to drive the locking assembly to move to control position locking and releasing of the telescopic supporting leg; and
the operating component is connected to driving components of the three telescopic supporting legs simultaneously.

The operating component includes an operating base, an operating handle, and three connecting ropes, the operating handle is rotatably disposed on the operating base, a reset torsion spring is disposed between the operating handle and the operating base, the operating handle is connected to ends of the three connecting ropes respectively, and other ends of the three connecting ropes are connected to the driving components of the three telescopic supporting legs respectively.

The operating component includes an operating base, a control circuit board mounted in the operating base, and a control button mounted on the operating base, and the control button and the driving component are electrically connected to the control circuit board respectively.

The operating component further includes a driving power supply, the driving power supply is mounted in the operating base, the tripod base, or a tube base, and the driving power supply is electrically connected to the control circuit board.

Beneficial effects of the present invention are as follows:

The present invention is novel in structure and ingenious in design. When the locking assembly is in the locking state, elastic force of the elastic component makes the locking assembly self-locking, and the transmission member is not needed to provide locking force or locking torque for the locking assembly, so that a user may drive, only by lightly applying force to the driving component, the transmission member to move to drive the locking assembly to perform unlocking to control position locking or releasing of the telescopic supporting leg. Since the transmission member may move by only applying small force, one operating component may simultaneously drive a plurality of transmission members to move. An operation is simple, use is convenient, and a problem that a traditional tripod needs to be adjusted through a plurality of unlocking and needs to be adjusted through an operation of two hands or cooperation of a plurality of persons is overcome, thereby greatly improving use convenience of the user.

### BRIEF DESCRIPTION OF THE DRAWINGS

FIG. 1 is a schematic structural diagram of a tripod according to the present invention;

FIG. 2 is an exploded structural view of a telescopic supporting leg according to the present invention;

FIG. 3 is a sectional view of a telescopic supporting leg according to the present invention;

FIG. 4 is an enlarged view of a position A in FIG. 3;

FIG. 5 is an exploded structural view of a driving component in Embodiment 2 according to the present invention;

FIG. 6 is an exploded structural view of a locking assembly in which an elastic component is hidden according to the present invention; and

FIG. 7 is a schematic structural diagram of an upper sleeve and a lower sleeve according to the present invention.

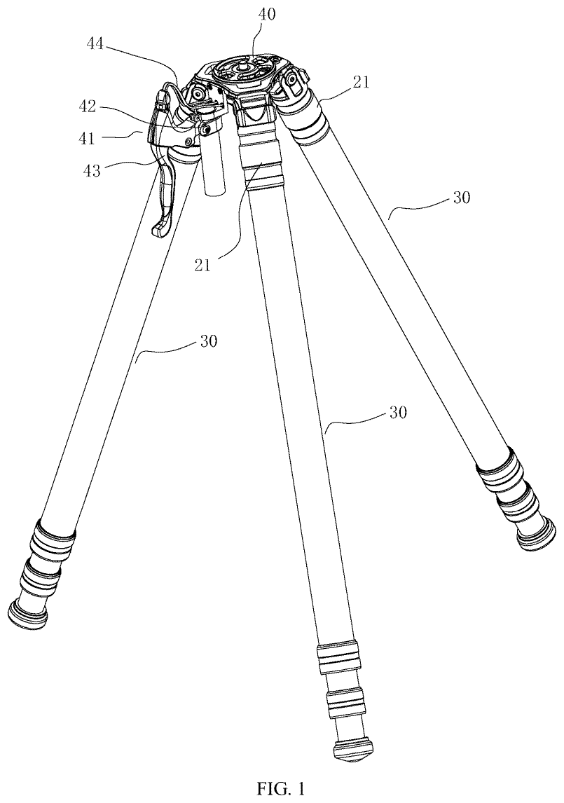

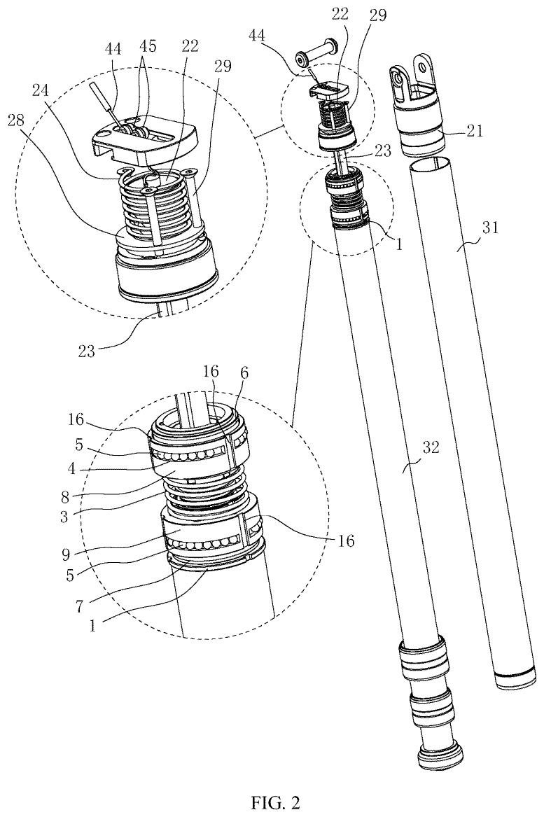

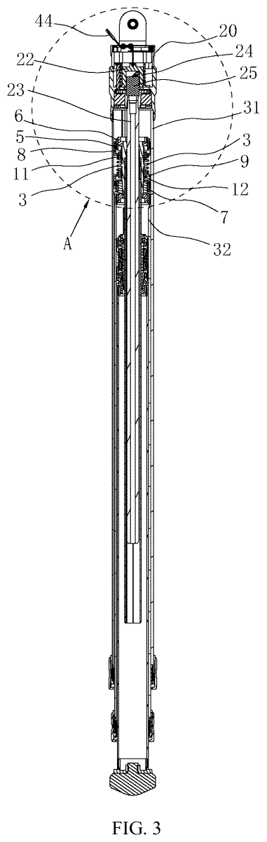

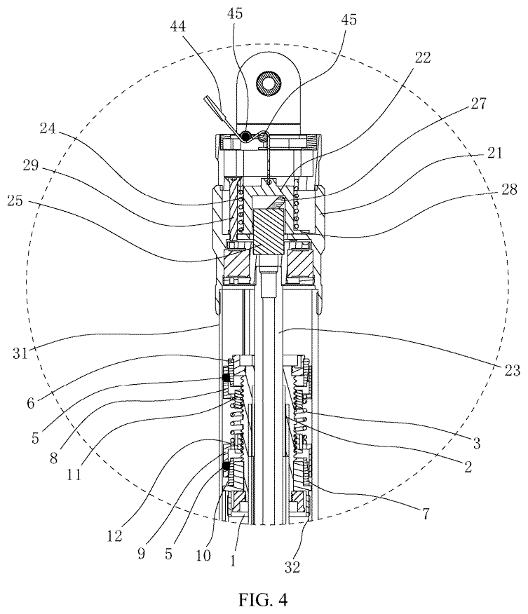

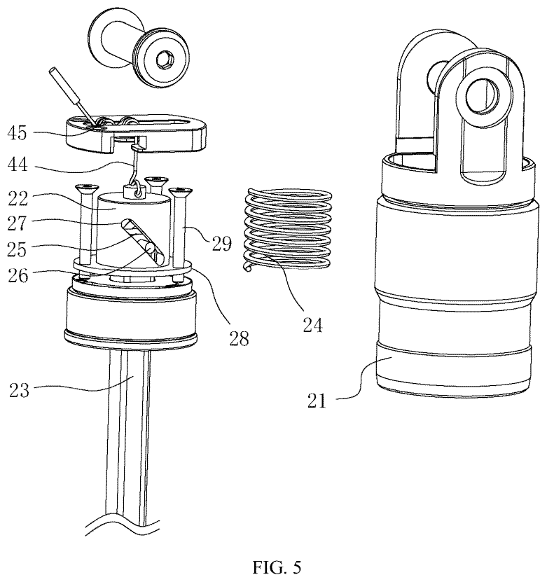

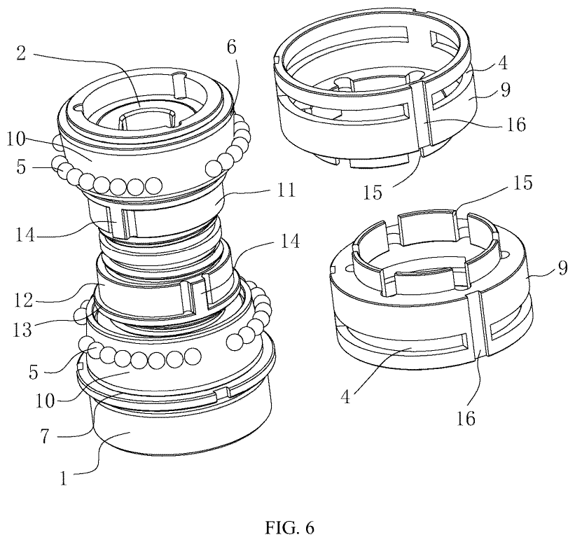

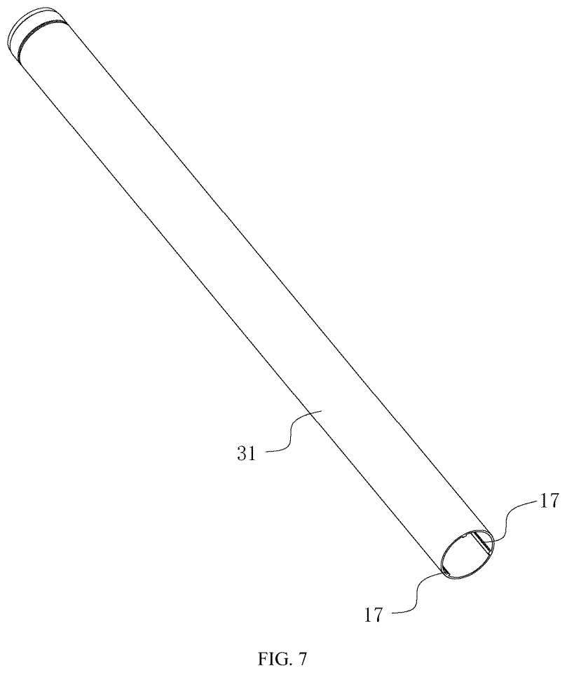

Reference numerals in FIG. 1 to FIG. 7 include:

1. fixing base; 2. rotating shaft member; 3. elastic component; 4. locking groove; 5. locking member; 6. first abutting ferrule; 7. second abutting ferrule; 8. first movable ferrule; 9. second movable ferrule; 10. abutting inclined surface; 11. first threaded ferrule; 12. second threaded ferrule; 13. limiting annular platform; 14. limiting rib; 15. limiting groove; 16. vertical groove; 17. vertical rib;

20. driving component; 21. tube base; 22. driving head; 23. transmission member; 24. reset spring; 25. connecting head; 26. pin shaft; 27. inclined groove; 28. reset annular platform; 29. limiting vertical shaft;

30. telescopic supporting leg; 31. upper sleeve; 32. lower sleeve;

40. tripod base; 41. operating component; 42. operating base; 43. operating handle; 44. connecting rope; 45. pulley.

### DETAILED DESCRIPTION OF THE EMBODIMENTS

The technical solutions in the embodiments of the present invention are clearly and completely described below with reference to FIG. 1 to FIG. 7 in the embodiments of the present invention. Apparently, the described embodiments are merely some rather than all of the embodiments of the present invention. Based on the embodiments of the present invention, all other embodiments obtained by those of ordinary skill in the art without making creative efforts shall fall within the protection scope of the present invention. It may be understood that the accompanying drawings are provided for reference and explanation only and are not intended to limit the present invention. The connection relationship shown in the accompanying drawings is only for the convenience of a clear description and does not limit the connection method.

It should be noted that when an assembly is referred to as being “connected” to another assembly, it may be directly connected to the another assembly, or there may be a centered assembly at the same time. Unless otherwise defined, all technical and scientific terms used herein have the same meaning as those commonly understood by a person skilled in the art of the present invention. It should be further noted that unless otherwise explicitly specified and limited, the terms “mount”, “interconnect”, and “connect” should be understood in a broad sense. For example, such terms may indicate a fixed connection, a detachable connection, or an integral connection; and may indicate a mechanical connection, an electrical connection, or internal communication between two elements. For those of ordinary skill in the art, the specific meanings of the above-mentioned terms in the present invention can be construed according to specific cases. The terms used in the specification of the present invention are merely for the purpose of describing specific embodiments, but are not intended to limit the present invention.

It should be further noted that in the description of the present invention, it should be noted that the orientations or positional relationships indicated by the terms “center”, “up”, “down”, “left”, “right”, “vertical”, “horizontal”, “inside”, “outside”, and the like are based on those shown in the accompanying drawings, intended only for the convenience of describing the present invention and for simplifying the description, and not intended to indicate or imply that the referred apparatus or element must be provided with a particular orientation or constructed and operated with a particular orientation, therefore not allowed to be construed as a limitation of the present invention. Furthermore, the terms “first”, “second”, and “third” are used for descriptive purposes only and are not allowed to be construed as indication or implication of relative importance.

### Embodiment 1

According to Embodiment 1, a locking assembly is provided and includes a fixing base 1 and a rotating shaft member 2 rotatably disposed on the fixing base 1. An abutting component is fixedly sleeved on a periphery of the rotating shaft member 2, an elastic component 3 and a movable component are disposed on the periphery of the rotating shaft member 2, the movable component is disposed on the periphery of the rotating shaft member 2 in a manner of moving up and down, each of two sides of the movable component is provided with a locking groove 4, and a locking member 5 is movably disposed in the locking groove 4. The rotating shaft member 2 rotates to drive the movable component to move up and down to be close to or away from the abutting component. In a locking state, the elastic component is compressed to enable the movable component to abut against the abutting component, the abutting component abuts against the locking member 5 to enable the locking member to extend out of the locking groove 4, and an outer wall of the movable component slidably abuts against an inner wall of an upper sleeve 31. Specifically, during moving, the locking assembly drives the rotating shaft member 2 to rotate in a forward direction, to drive the movable component to move up and down. When the movable component is close to the abutting component, the abutting component abuts against and pushes out the locking member 5 in the locking groove 4 to enable the locking member 5 to extend out of the locking groove 4 to rub against and abut against the inner wall of the upper sleeve 31, to implement locking. In the locking state, the elastic component 3 is in a compression state, elastic force of the elastic component 3 enables the movable component to abut against the abutting component, the abutting component abuts against the locking member 5 to enable the locking member to extend out of the locking groove 4, and the locking assembly is in a self-locking state. The locking assembly drives the rotating shaft member 2 to rotate in an inverse direction, to drive the movable component to move up and down. When the movable component is away from the abutting component, the abutting component is away from the locking member 5 in the locking groove 4, and the locking member 5 is retracted into the locking groove 4, to implement unlocking. When the abutting component abuts against and pushes out the locking member 5 in the locking groove 4 to enable the locking member 5 to extend out of the locking groove 4, the elastic component 3 applies force to the movable component, to enable the movable component to continuously be close to the abutting component, to increase pull-out force applied by the abutting component to the locking member 5, to improve static friction force between the locking member 5 and the inner wall of the upper sleeve 31, thereby improving a locking effect. A structure is reliable and stable.

Further, the abutting component includes a first abutting ferrule 6 and a second abutting ferrule 7, and the first abutting ferrule 6 and the second abutting ferrule 7 are fixedly sleeved at an upper end and a lower end of the rotating shaft member 2 respectively.

The movable component includes a first movable ferrule 8 and a second movable ferrule 9, and the first movable ferrule 8 and the second movable ferrule 9 are located between the first abutting ferrule 6 and the second abutting ferrule 7.

The elastic component 3 is located between the first movable ferrule 8 and the second movable ferrule 9, and two ends of the elastic component 3 abut against the first movable ferrule 8 and the second movable ferrule 9 respectively. The movable component further includes a first threaded ferrule 11 and a second threaded ferrule 12, the first threaded ferrule 11 and the second threaded ferrule 12 are located between the first abutting ferrule 6 and the second abutting ferrule 7, and the first movable ferrule 8 and the second movable ferrule 9 are located between the first threaded ferrule 11 and the second threaded ferrule 12.

A left-hand thread or a right-hand thread of the upper end of the rotating shaft member 2 is directly or indirectly connected to the first threaded ferrule 11, and a right-hand thread or a left-hand thread of the lower end of the rotating shaft member 2 is directly or indirectly connected to the second threaded ferrule 12. The first movable ferrule 8 is sleeved on a periphery of the first threaded ferrule 11 in a manner of moving up and down, and the second movable ferrule 9 is sleeved on a periphery of the second threaded ferrule 12 in a manner of moving up and down.

Specifically, under the above disposing, during rotation, the rotating shaft member 2 may drive the first threaded ferrule 11 and the second threaded ferrule 12 to oppositely move close to each other, and the first threaded ferrule 11 and the second threaded ferrule 12 may drive the first movable ferrule 8 and the second movable ferrule 9 to be away from the first abutting ferrule 6 and the second abutting ferrule 7 respectively, thereby facilitating implementing unlocking to implement position releasing. When the rotating shaft member drives the first threaded ferrule 11 and the second threaded ferrule to oppositely move away from each other, the first movable ferrule 8 and the second movable ferrule 9 are close to the first abutting ferrule 6 and the second abutting ferrule 7 respectively under the action of the elastic component 3 and push the locking member 5 under the action of the first abutting ferrule 6 and the second abutting ferrule 7. When the elastic component 3 provides elastic force, to enable the first movable ferrule 8 and the second movable ferrule 9 to be closer to the first abutting ferrule 6 and the second abutting ferrule 7, force of pushing the locking member 5 to extend out of the locking groove 4 by the first abutting ferrule 6 and the second abutting ferrule 7 is greater, to improve static friction between the locking member 5 and the inner wall of the upper sleeve 31, thereby improving the locking effect.

In the embodiment, a limiting annular platform 13 is disposed on the periphery of the first threaded ferrule 11 and the periphery of the second threaded ferrule 12 respectively, an inner wall of the first movable ferrule 8 is attached to the limiting annular platform 13 of the first threaded ferrule 11 in an abutting manner, and an inner wall of the second movable ferrule 9 is attached to the limiting annular platform 13 of the second threaded ferrule 12. Specifically, under the disposing, the limiting annular platform 13 supports the first movable ferrule 8 and the second movable ferrule 9. When the first threaded ferrule 11 and the second threaded ferrule 12 oppositely move close to each other, the first movable ferrule 8 and the second movable ferrule 9 are driven to move close to each other in the opposite direction. When the first threaded ferrule 11 and the second threaded ferrule 12 oppositely move away from each other, the first movable ferrule 8 and the second movable ferrule 9 are away from each other oppositely under the action of the elastic component 3. In addition, the limiting annular platform plays a limiting and supporting role, to prevent the first movable ferrule 8 and the second movable ferrule 9 from being separated from the first threaded ferrule 11 and the second threaded ferrule 12, thereby facilitating driving the first movable ferrule 8 and the second movable ferrule 9 to oppositely move close to each other to perform locking.

In the embodiment, a limiting assembly is disposed between the first threaded ferrule 11 and the first movable ferrule 8 and between the second threaded ferrule 12 and the second movable ferrule 9 respectively. Specifically, the limiting assembly is mainly configured to limit the first movable ferrule 8 and the second movable ferrule 9 to only move up and down, thereby avoiding mutual rotation thereof to affect the locking effect.

The limiting assembly includes at least one limiting rib 14 and at least one limiting groove 15, the limiting rib 14 is adapted and slidably connected to the limiting groove 15, the periphery of the first threaded ferrule 11 and the periphery of the second threaded ferrule 12 are provided with the limiting rib 14 and/or the limiting groove 15 respectively, and an inner wall of the first movable ferrule 8 and an inner wall of the second movable ferrule 9 are provided with the limiting groove 15 and/or the limiting rib 14 respectively. Specifically, under the disposing, the limiting rib 14 is slidably connected to the limiting groove 15, and the limiting rib 14 and the limiting groove 15 are disposed vertically, so that horizontal directions between the first movable ferrule 8 and the first threaded ferrule 11 and between the second movable ferrule 9 and the second threaded ferrule 12 are locked. Further, a peripheral wall of the first movable ferrule 8 and a peripheral wall of the second movable ferrule 9 are vertically provided with a vertical groove 16 and/or a vertical rib 17 respectively. Specifically, under the disposing, the vertical groove 16 and/or the vertical rib 17 of the first movable ferrule 8 and the second movable ferrule 9 are adapted to a vertical rib 17 and/or a vertical groove 16 of the inner wall of the upper sleeve 31 and a lower sleeve 32, thereby ensuring that the first movable ferrule 8 and the second movable ferrule 9 can only move up and down without relative rotation.

In the embodiment, one side, abutting against the locking member 5, of each of the first abutting ferrule 6 and the second abutting ferrule 7 is provided with an abutting inclined surface 10 configured to abut against the locking member 5 in a matching manner. Specifically, the locking member 5 is pushed to extend out of the locking groove 4 through the abutting inclined surface 10 to abut against the inner wall of the upper sleeve 31, thereby implementing position locking between the upper sleeve 31 and the lower sleeve 32.

In the embodiment, cross sections of the first abutting ferrule 6 and/or the second abutting ferrule 7 are of an isosceles trapezoid shape and/or a circular truncated cone shape. Under the above disposing, the first abutting ferrule 6 and the second abutting ferrule 7 can abut against and push the locking member 5, and the first movable ferrule 8 and the second movable ferrule 9 can be pushed to be close to the first abutting ferrule 6 and the second abutting ferrule 7 respectively with cooperation of the elastic action of the elastic component 3. Under the above disposing, the locking member 5 is abutted to enable the locking member 5 to extend out of the locking groove 4 to abut against the inner wall of the upper sleeve 31, thereby locking a position between the upper sleeve 31 and the lower sleeve 32.

In the embodiment, the locking groove 4 is a horizontal locking groove 4; and the locking member 5 is an arc-shaped circular strip colloid or a plurality of beads movably arranged in the horizontal locking groove 4 in a raw. The beads may be globoid steel balls or plastic beads. Each of an outer side and an inner side of the horizontal locking groove 4 is provided with an opening, to facilitate abutting against the beads. The height of the opening may be slightly less than the diameter of the beads, to prevent the beads from falling off.

### Embodiment 2

According to Embodiment 2, a driving-type locking mechanism is provided and includes a driving component 20 and the locking assembly, and the driving component 20 is configured to drive the rotating shaft member 2 to rotate. Specifically, under the disposing, the rotating shaft member 2 is driven to implement that the locking assembly performs locking or unlocking.

The driving component 20 is of a mechanical driving structure. The driving component 20 includes a tube base 21, a driving head 22, a transmission member 23, and a reset spring 24. One end of the transmission member 23 is connected to the driving head 22, and the other end of the transmission member 23 is connected to the rotating shaft member 2. The transmission member 23 is rotatably connected to the tube base 21, and the driving head 22 is disposed in the tube base 21 in a manner of moving up and down. The reset spring 24 is connected between the driving head 22 and the tube base 21, and the reset spring 24 is configured to drive the driving head 22 to reset. The transmission member 23 is rotatable relative to the tube base 21, and the driving head 22 is configured to drive the transmission member 23 to rotate. Further, a connecting head 25 is disposed at one end of the transmission member 23, a pin shaft 26 is disposed on each of two sides of the connecting head 25, and the connecting head 25 is located in the driving head 22. Each of two sides of the driving head 22 is provided with an inclined groove 27, and the pin shaft 26 on each of the two sides of the connecting head 25 extends into the inclined groove 27. The reset spring 24 is an elastic reset spring 24 and may be a compression spring. The transmission member 23 may be of a transmission rod structure.

Specifically, during working of the driving component 20, an operating component 41 drives the driving head 22 to move upward, and the reset spring 24 is compressed. Under the matching of the pin shaft 26 and the inclined groove 27, when the driving head 22 moves upward, the connecting head 25 is driven to rotate, so that the transmission member 23 rotates. The transmission member 23 rotates to drive the rotating shaft member 2 to rotate, and under the rotation of the rotating shaft member 2, a first movable ferrule 8 and a second movable ferrule 9 are driven to oppositely move close to each other, so that a locking member 5 is separated from pushing of a first abutting ferrule 6 and a second abutting ferrule 7, to implement unlocking of the locking assembly. Details are mentioned above and are not described in detail herein. When the driving head 22 is released, under the elastic action of the reset spring 24, the driving head 22 is pushed to reset and move downward, and the connecting head 25 is driven to rotate inversely, so that the transmission member 23 rotates inversely. Then, the rotating shaft member 2 is driven to rotate inversely to drive the first movable ferrule 8 and the second movable ferrule 9 to oppositely move away from each other, so that the first movable ferrule 8 and the second movable ferrule 9 are matched with the first abutting ferrule 6 and the second abutting ferrule 7 respectively to push the locking member 5 to extend out of a locking groove 4 to generate static friction with an inner wall of an upper sleeve 31 to implement locking. The above are all mechanical structures, to drive the locking assembly to perform locking or unlocking.

A reset annular platform 28 is disposed on a peripheral wall of the driving head 22, the reset spring 24 is sleeved on a periphery of the driving head 22, and two ends of the reset spring 24 abut against inner walls of the reset annular platform 28 and the tube base 21 respectively. Specifically, under the disposing, it is convenient for the reset spring 24 to push the reset annular platform 28 to enable the driving head 22 to reset. The structural design is novel and ingenious.

Further, at least two limiting vertical shafts 29 are disposed in the tube base 21, and the limiting vertical shaft 29 slidably penetrates through the reset annular platform 28. Specifically, under the disposing, a moving direction of the driving head 22 is limited, to ensure that the driving head 22 can only move up and down along the tube base 21 without relative rotation, thereby ensuring stability and reliability of normal work of the driving head 22.

### Embodiment 3

Embodiment 3 differs from Embodiment 2 in that: A driving component 20 in Embodiment 3 is of an electric driving structure. The driving component 20 includes a tube base 21, a micro motor, and a transmission member 23. The micro motor is fixedly mounted in the tube base 21, the micro motor is drivingly connected to the transmission member 23, the transmission member 23 is rotatably connected to the tube base 21, the micro motor is configured to drive the transmission member 23 to rotate, and the other end of the transmission member 23 is connected to the rotating shaft member 2. An output shaft of the micro motor is drivingly connected to one end of the transmission member 23. Specifically, under the disposing, a driving member (that is, the micro motor) is turned on through a control button, and the output shaft of the driving member rotates to drive the transmission member 23 to rotate, to drive the rotating shaft member 2 to rotate, to implement locking or unlocking of the locking assembly without human participation, thereby improving use convenience and reducing costs of mechanical parts and assembly costs.

### Embodiment 4

According to Embodiment 4, a telescopic supporting leg 30 is provided and includes the driving-type locking mechanism, at least one upper sleeve 31 that is hollow, and a lower sleeve 32 that can move up and down in the upper sleeve 31. The driving component 20 is mounted on the upper sleeve 31, and the locking assembly is mounted at an upper end of the lower sleeve 32. A fixing base 1 is fixed at the upper end of the lower sleeve 32, and the driving component 20 is configured to drive a rotating shaft member 2 of the locking assembly to rotate. Specifically, under the disposing, the upper sleeve 31 and the lower sleeve 32 may move up and down relative to each other. When position locking needs to be performed, the driving component 20 is driven to move, to drive the locking assembly to perform locking or unlocking, to lock a position between the upper sleeve 31 and the lower sleeve 32.

In the embodiment, a peripheral wall of the movable component is vertically provided with a vertical groove 16 and/or a vertical rib 17; and an inner wall of the upper sleeve 31 and an inner wall of the lower sleeve 32 are respectively provided with a matched vertical rib 17 and/or vertical groove 16. Specifically, under the disposing, the upper sleeve 31 and the lower sleeve 32 can only move up and down relative to each other without relative rotation, and the movable component can only move up and down without relative rotation, thereby ensuring stable locking between the movable component and an abutting component.

### Embodiment 5

According to Embodiment 5, a tripod is provided and includes a tripod base 40, an operating component 41 mounted on the tripod base 40, and three telescopic supporting legs 30 annularly disposed on a periphery of the tripod base 40 in a uniformly-spaced manner. The telescopic supporting leg 30 includes a driving-type locking mechanism, at least one upper sleeve 31 that is hollow, and a lower sleeve 32 that can move up and down in the upper sleeve 31. The driving-type locking mechanism includes a driving component 20 and a locking assembly. The driving component 20 is mounted at an upper end of the upper sleeve 31, the locking assembly is mounted at an upper end of the lower sleeve 32, and the driving component 20 is configured to drive the locking assembly to move to control position locking and releasing of the telescopic supporting leg 30. The operating component 41 is connected to driving components 20 of the three telescopic supporting legs simultaneously.

Further, the driving component 20 includes a tube base 21, a driving head 22, a transmission member 23, and a reset spring 24. One end of the transmission member 23 is connected to the driving head 22, and the other end of the transmission member 23 is connected to the rotating shaft member 2. The transmission member 23 is rotatably connected to the tube base 21, and the driving head 22 is disposed in the tube base 21 in a manner of moving up and down. The reset spring 24 is connected between the driving head 22 and the tube base 21, and the driving head 22 is configured to drive the transmission member 23 to rotate. A connecting head 25 is disposed at one end of the transmission member 23, a pin shaft 26 is disposed on each of two sides of the connecting head 25, and the connecting head 25 is located in the driving head 22. Each of two sides of the driving head 22 is provided with an inclined groove 27, and the pin shaft 26 on each of the two sides of the connecting head 25 extends into the inclined groove 27. The operating component 41 includes an operating base 42, an operating handle 43, and three connecting ropes 44. The operating handle 43 is rotatably disposed on the operating base 42, a reset torsion spring is disposed between the operating handle 43 and the operating base 42, the operating handle 43 is connected to ends of the three connecting ropes 44 respectively, and other ends of the three connecting ropes 44 are connected to the driving heads 22 of the three telescopic supporting legs respectively.

Two pulleys 45 are rotatably disposed in the tube base 21, and the connecting rope 44 is connected to an upper end of the driving head 22 after bypassing the two pulleys 45. Under the disposing, smoothness and stability of the connecting rope 44 pulling the driving head 22 are improved, wear on the connecting rope 44 is reduced, and a service life is improved.

The tripod in Embodiment 5 is mechanically operated. A feature of Embodiment 5 is that the operating component 41 may be used to control the driving components 20 in the three telescopic supporting legs 30 to work to simultaneously drive the locking assembly in the three telescopic supporting legs 30 to perform locking or unlocking.

Specifically, during use, a user presses the operating handle 43, to pull the connecting rope 44, to drive the driving head 22 to move upward, and the reset spring 24 is compressed. Under the matching of the pin shaft 26 and the inclined groove 27, when the driving head 22 moves upward, the connecting head 25 is driven to rotate, so that the transmission member 23 rotates. The transmission member 23 rotates to drive the rotating shaft member 2 to rotate, and under the rotation of the rotating shaft member 2, a first movable ferrule 8 and a second movable ferrule 9 are driven to oppositely move close to each other, so that a locking member 5 is separated from pushing of a first abutting ferrule 6 and a second abutting ferrule 7, to implement unlocking of the locking assembly. Details are mentioned above and are not described in detail herein. When the operating handle 43 is released, under the elastic action of the reset torsion spring, the operating handle 43 is reset, and the connecting rope 44 and the driving head 22 are released. Under the elastic action of the reset spring 24, the driving head 22 is pushed to reset and move downward, and the connecting head 25 is driven to rotate inversely, so that the transmission member 23 rotates inversely. Then, the rotating shaft member 2 is driven to rotate inversely to drive the first movable ferrule 8 and the second movable ferrule 9 to oppositely move away from each other, so that the first movable ferrule 8 and the second movable ferrule 9 are matched with the first abutting ferrule 6 and the second abutting ferrule 7 respectively to push the locking member 5 to extend out of a locking groove 4 to generate static friction with an inner wall of the upper sleeve 31 to implement locking. The above are all mechanical structures, to drive the locking assembly to perform locking or unlocking. Furthermore, in the embodiment, the user presses the operating handle 43 with a single hand, to control the locking assembly in the three telescopic supporting legs 30 to perform locking or unlocking. An operation is simple, and a problem that a traditional tripod needs to be adjusted through a plurality of unlocking and needs to be adjusted through an operation of two hands or cooperation of a plurality of persons is overcome, thereby greatly improving use convenience of the user.

### Embodiment 6

A tripod in Embodiment 6 differs from the tripod in Embodiment 5 in that: Embodiment 6 provides an electronic control tripod. The driving component 20 includes a tube base 21, a micro motor, and a transmission member 23. The micro motor is fixedly mounted in the tube base 21, the micro motor is drivingly connected to the transmission member 23, the transmission member 23 is rotatably connected to the tube base 21, the micro motor is configured to drive the transmission member 23 to rotate, and the other end of the transmission member 23 is connected to the rotating shaft member 2.

The operating component 41 includes an operating base 42, a control circuit board mounted in the operating base 42, and a control button mounted on the operating base 42, and the control button and the micro motor are electrically connected to the control circuit board respectively.

Preferably, an output shaft of the micro motor is drivingly connected to one end of the transmission member 23. The operating component 41 further includes a driving power supply, the driving power supply is mounted in the operating base 42, a tripod base 40, or the tube base 21, and the driving power supply is electrically connected to the control circuit board.

Specifically, the control button in Embodiment 6 includes a forward rotating button and an inverse rotating button that respectively control an output shaft of the above driving member to rotate forwardly and inversely. The driving member is turned on to drive the transmission member 23 to rotate forwardly or inversely, to drive a first threaded ferrule 11 and a second threaded ferrule 12 to oppositely move away from each other or close to each other, thereby implementing locking or unlocking of a locking assembly. Unlocking and locking principles of the locking assembly have been described above and are not described in detail herein again. A feature of the Embodiment 6 is an electronic control operation. A user may unlock or lock three telescopic supporting legs 30 of the tripod by operating the control button without additional operations. The operation is simpler than that in Embodiment 5, tube joints of the tripod do not need to be locked or unlocked separately, and two hands of the user are freed.

Furthermore, a Bluetooth module, a WIFI module, a 4G networking module, and/or a 5G networking module are further disposed on the control circuit board of Embodiment 6, which may be wirelessly connected to a mobile phone or an intelligent terminal of the user. The above driving member may be controlled to be turned on and turned off through the mobile phone or the intelligent terminal of the user, making the use more intelligent and popular.

The above-described embodiments are only preferred embodiments of the present invention and constitute no restriction in any form on the present invention. Although the present invention has been disclosed above with preferred embodiments, such preferred embodiments are not intended to limit the present invention, and any person skilled in the art can make some changes or modifications to equivalent embodiments with equivalent changes by reference to the technical content disclosed above without departing from the scope of the technical solutions of the present invention. However, any simple revisions, equivalent changes, and modifications made to the above embodiments in accordance with the technical essence of the present invention without departing from the content of the technical solutions of the present invention shall still fall within the scope of the technical solutions of the present invention.

What is claimed is:

1. A locking assembly, comprising a fixing base and a rotating shaft member rotatably disposed on the fixing base, wherein an abutting component is fixedly sleeved on a periphery of the rotating shaft member, an elastic component and a movable component are disposed on the periphery of the rotating shaft member, the movable component is disposed on the periphery of the rotating shaft member in a manner of moving up and down, the movable component is provided with a locking groove, and a locking member is movably disposed in the locking groove; the rotating shaft member rotates to drive the movable component to move up and down to be close to or away from the abutting component; and in a locking state, the elastic component is compressed to enable the movable component to abut against the abutting component, and the abutting component abuts against the locking member to enable the locking member to extend out of the locking groove.

2. The locking assembly according to claim 1, wherein the abutting component comprises a first abutting ferrule and a second abutting ferrule, and the first abutting ferrule and the second abutting ferrule are fixedly sleeved at an upper end and a lower end of the rotating shaft member respectively;
the movable component comprises a first movable ferrule and a second movable ferrule, and the first movable ferrule and the second movable ferrule are located between the first abutting ferrule and the second abutting ferrule;
the elastic component is located between the first movable ferrule and the second movable ferrule, and two ends of the elastic component abut against the first movable ferrule and the second movable ferrule respectively; and
cross sections of the first abutting ferrule and/or the second abutting ferrule are of an isosceles trapezoid shape and/or a circular truncated cone shape.

3. The locking assembly according to claim 2, wherein one side, abutting against the locking member, of each of the first abutting ferrule and the second abutting ferrule is provided with an abutting inclined surface configured to abut against the locking member in a matching manner.

4. The locking assembly according to claim 2, wherein the movable component further comprises a first threaded ferrule and a second threaded ferrule, the first threaded ferrule and the second threaded ferrule are located between the first abutting ferrule and the second abutting ferrule, and the first movable ferrule and the second movable ferrule are located between the first threaded ferrule and the second threaded ferrule;
a left-hand thread or a right-hand thread of the upper end of the rotating shaft member is directly or indirectly connected to the first threaded ferrule, and a right-hand thread or a left-hand thread of the lower end of the rotating shaft member is directly or indirectly connected to the second threaded ferrule;
the first movable ferrule is sleeved on a periphery of the first threaded ferrule in a manner of moving up and down, and the second movable ferrule is sleeved on a periphery of the second threaded ferrule in a manner of moving up and down; and
a limiting assembly is disposed between the first threaded ferrule and the first movable ferrule and between the second threaded ferrule and the second movable ferrule respectively.

5. The locking assembly according to claim 4, wherein a limiting annular platform is disposed on the periphery of the first threaded ferrule and the periphery of the second threaded ferrule respectively, an inner wall of the first movable ferrule is attached to the limiting annular platform of the first threaded ferrule in an abutting manner, and an inner wall of the second movable ferrule is attached to the limiting annular platform of the second threaded ferrule in an abutting manner.

6. The locking assembly according to claim 4, wherein the limiting assembly comprises at least one limiting rib and at least one limiting groove, the limiting rib is adapted and slidably connected to the limiting groove, the periphery of the first threaded ferrule and the periphery of the second threaded ferrule are provided with the limiting rib and/or the limiting groove respectively, and an inner wall of the first movable ferrule and an inner wall of the second movable ferrule are provided with the limiting groove and/or the limiting rib respectively.

7. The locking assembly according to claim 1, wherein the locking groove is a horizontal locking groove; and the locking member is an arc-shaped circular strip colloid or a plurality of beads movably arranged in the horizontal locking groove in a raw.

8. The locking assembly according to claim 2, wherein a peripheral wall of the first movable ferrule and a peripheral wall of the second movable ferrule are vertically provided with a vertical groove and/or a vertical rib respectively.

9. A driving-type locking mechanism, comprising a driving component and the locking assembly according to claim 1, wherein the driving component is configured to drive the rotating shaft member to rotate.

10. The driving-type locking mechanism according to claim 9, wherein the driving component comprises a tube base, a driving head, a transmission member, and a reset spring, one end of the transmission member is connected to the driving head, the other end of the transmission member is connected to the rotating shaft member, the driving head is disposed in the tube base in a manner of moving up and down, the reset spring is configured to drive the driving head to reset, the transmission member is rotatable relative to the tube base, and the driving head is configured to drive the transmission member to rotate.

11. The driving-type locking mechanism according to claim 10, wherein a connecting head is disposed at one end of the transmission member, a pin shaft is disposed on each of two sides of the connecting head, the connecting head is located in the driving head, each of two sides of the driving head is provided with an inclined groove, and the pin shaft on each of the two sides of the connecting head extends into the inclined groove.

12. The driving-type locking mechanism according to claim 10, wherein a reset annular platform is fixedly disposed on a peripheral wall of the driving head, the reset spring is sleeved on a periphery of the driving head, and two ends of the reset spring abut against inner walls of the reset annular platform and the tube base respectively.

13. The driving-type locking mechanism according to claim 12, wherein at least two limiting vertical shafts are disposed in the tube base, and the limiting vertical shaft slidably penetrates through the reset annular platform.

14. The driving-type locking mechanism according to claim 9, wherein the driving component comprises a tube base, a micro motor, and a transmission member, an output shaft of the micro motor is drivingly connected to one end of the transmission member, one end of the transmission member is connected to the rotating shaft member, the transmission member is rotatable relative to the tube base, and the micro motor is mounted in the tube base.

15. A telescopic supporting leg, comprising the driving-type locking mechanism according to claim 9, at least one upper sleeve that is hollow, and a lower sleeve that can move up and down in the upper sleeve, wherein the driving component is mounted at an upper end of the upper sleeve, and the locking assembly is mounted at an upper end of the lower sleeve.

16. The telescopic supporting leg according to claim 15, wherein a peripheral wall of the movable component is vertically provided with a vertical groove and/or a vertical rib; and an inner wall of the upper sleeve and an inner wall of the lower sleeve are respectively provided with a matched vertical rib and/or vertical groove.

17. A tripod, comprising a tripod base, an operating component mounted on the tripod base, and three telescopic supporting legs annularly disposed on a periphery of the tripod base in a uniformly-spaced manner according to claim 15, wherein the operating component is connected to driving components of the three telescopic supporting legs simultaneously.

18. The tripod according to claim 17, wherein the operating component comprises an operating base, an operating handle, and three connecting ropes, the operating handle is rotatably disposed on the operating base, a reset torsion spring is disposed between the operating handle and the operating base, the operating handle is connected to ends of the three connecting ropes respectively, and other ends of the three connecting ropes are connected to the driving components of the three telescopic supporting legs respectively.

19. The tripod according to claim 17, wherein the operating component comprises an operating base, a control circuit board mounted in the operating base, and a control button mounted on the operating base, and the control button and the driving component are electrically connected to the control circuit board respectively.

20. The tripod according to claim 19, wherein the operating component further comprises a driving power supply, the driving power supply is mounted in the operating base, the tripod base, or a tube base, and the driving power supply is electrically connected to the control circuit board.

21. A tripod, comprising a tripod base, an operating component mounted on the tripod base, and three telescopic supporting legs annularly disposed on a periphery of the tripod base in a uniformly-spaced manner;
the telescopic supporting leg comprises a driving-type locking mechanism, at least one upper sleeve that is hollow, and a lower sleeve that can move up and down in the upper sleeve; and the driving-type locking mechanism comprises a driving component and a locking assembly, the driving component is mounted at an upper end of the upper sleeve, the locking assembly is mounted at an upper end of the lower sleeve, and the driving component is configured to drive the locking assembly to move to control position locking and releasing of the telescopic supporting leg; and
the operating component is connected to driving components of the three telescopic supporting legs simultaneously.

22. The tripod according to claim 21, wherein the operating component comprises an operating base, an operating handle, and three connecting ropes, the operating handle is rotatably disposed on the operating base, a reset torsion spring is disposed between the operating handle and the operating base, the operating handle is connected to ends of the three connecting ropes respectively, and other ends of the three connecting ropes are connected to the driving components of the three telescopic supporting legs respectively.

23. The tripod according to claim 21, wherein the operating component comprises an operating base, a control circuit board mounted in the operating base, and a control button mounted on the operating base, and the control button and the driving component are electrically connected to the control circuit board respectively.

24. The tripod according to claim 21, wherein the operating component further comprises a driving power supply, the driving power supply is mounted in the operating base, the tripod base, or a tube base, and the driving power supply is electrically connected to the control circuit board.
